(19) United States
(12) Patent Application Publication
(10) Pub. No.: US 2009/0128861 A1
(43) Pub. Date: May 21, 2009

(54) Systems and Methods for Communicating Multimodal Messages

(75) Inventors: Francis Toscano, Kendall Park, NJ (US); Michael Alexander Preobrazhensky, Boulder, CO (US)

Correspondence Address: SMITH FROHWEIN TEMPEL GREENLEE BLAHA, LLC, Two Ravinia Drive, Suite 700, ATLANTA, GA, 30346, US

(73) Assignee: Xpedite Systems, LLC, Alanta, GA (US)

(21) Appl. No.: 12/358,851

(22) Filed: Jan. 23, 2009

Related U.S. Application Data
(63) Continuation-in-part of application No. 11/852,315, filed on Sep. 9, 2007.

(51) Int. Cl. H04N 1/00

(52) U.S. Cl. 358/400

(57) ABSTRACT

A dynamic message delivery system includes an answer detector and a message manager. The message manager establishes a call. The answer detector determines when one of a facsimile machine, a voicemail system or a live speaker answers the call. The message manager responds by delivering one of the primary message or the alternate message. The primary message is in an intended format for delivery to the recipient. The alternate message is in a second format that is different than the intended format.

### BACKGROUND

Telephone systems are used to conduct real time two-way voice communications. Traditional terrestrial based telephone systems connect one telephone set to another through one or more switching centers, operated by one or more telephone companies, over a terrestrial based telephone network which is typically a circuit-switched network.

Facsimile (fax) technology has been a successful means to transmit printed or handwritten messages electronically over circuit-switched networks. With the emergence of publicly accessible data networks and electronic mail (e-mail) applications, it appeared that fax communications would be rapidly replaced by e-mail. However, it is now clear that the two technologies will continue to co-exist.

Current telephone systems may also use a packet-switched network to complete a telephone connection. A packet-switched network is typical in a computer data environment. Recent developments in the field of Voice over Internet Protocol (VoIP) allow the delivery of voice information using the Internet Protocol (IP), in which voice information is packaged in a digital form of discrete packets rather than in the traditional circuit-committed protocols of the public-switched telephone network (PSTN).

A fax server uses specialized interface circuits for converting information communicated by users of a fax service. Generally, the originator of a message delivers the message and associated instructions in an electronic format to the fax server. When a message arrives at the fax server, the fax server converts the document into a format that is suitable for transmission over the PSTN. Thereafter, the fax server sends the converted document over the PSTN via its dedicated interface circuits in accordance with the associated instructions for delivering the message. Conversely, for a fax arriving at the fax server over the PSTN, the fax server identifies the destination user from the phone number, converts the incoming fax transmission into a format suitable for delivery to the destination user, and sends the converted document to the destination user over an IP (i.e., a data) network. For example, a fax is received at the fax server over the PSTN for customer A. Customer A prefers to receive fax messages via electronic mail at address “customerA@businessname.com.” In turn, the fax server converts the received fax to a document format file and inserts the same as an attachment in an email message addressed to Customer A.

Federal Communication Commission (FCC) regulations require the sender of a fax message (the party that initiates the call) to include identifying information on the fax message rather than the ultimate source of the information delivered in the fax message. When a fax service is used, the source of a delivered fax message is a customer of the fax service. Thus, the source of the communicated fax message may be a corporation, an organization, or an individual, whereas the sender may be an operator of a fax service. As a result, it is common for an operator of a fax service to receive complaints when fax messages are delivered or attempted to be delivered to an incorrect destination. Unsolicited advertisements delivered via a fax service are another source of common complaints received by the operator of a fax service.

In addition to an incorrect destination number, the delivery of a fax message can fail for various reasons outside the control of the operator of a fax service. For example, a destination fax machine could be out of paper, a destination fax machine might not be configured to automatically answer, a human might answer the call, an answering machine might answer the call, among others.

Similarly, the delivery of a voice-based message can also fail for a variety of reasons. For example, a called party may not have an answering machine or subscribe to a voicemail service, a voicemail system or answering machine may have reached its capacity to store or record additional messages, a fax machine may answer the call, etc. To address these known problems, message delivery systems are often configured to retry to deliver the message to the destination number, to forward the message to one or more alternative destination numbers, or apply other similar options. However, retrying a call to an incorrect destination or sending a repeat message to a destination number associated with a device that is not capable of handling the message does not resolve the underlying problem.

### SUMMARY

An embodiment of a dynamic message delivery system comprises a public-switched telephone network interface, a detector, and a message manager. The public-switched telephone network interface is coupled to the public-switched telephone network. The detector is coupled to the public-switched telephone network interface and generates an indicator in response to an answer type. The message manager is coupled to the public-switched telephone network interface and the detector. The message manager receives the indicator and identifies a primary message and an alternate message to be delivered to a recipient. The primary message is compatible with an intended format for delivery to the recipient. The alternate message is compatible with a second format that is different from the intended format for delivery to the recipient. The message manager is further configured to deliver one of the primary message or the alternate message to the intended recipient in response to the indicator.

An embodiment of a method for processing a message includes the following steps: identifying a primary message to be delivered to a recipient, the primary message being compatible with an intended format for delivery to the recipient, associating at least one alternate message with the primary message, the alternate message being compatible with a second format different from the intended format for delivery to the recipient, initiating a call using a destination number associated with the recipient and delivering one of the primary message and the alternate message to the recipient during the call in response to an answer type.

Other devices, methods, features and advantages will be or will become apparent to one skilled in the art upon examination of the following figures and detailed description. All such additional devices, methods, features and advantages are defined and protected by the accompanying claims.

### BRIEF DESCRIPTION OF THE DRAWINGS

The present systems and methods for communicating multimodal messages, as defined in the claims, can be better understood with reference to the following drawings. The components within the drawings are not necessarily to scale relative to each other; emphasis instead is placed upon clearly illustrating the elements, features and principles involved in supporting the delivery of multimodal messages dynamically in real time.

FIG. 1 is a functional block diagram illustrating an embodiment of an example network environment.

FIG. 2 is a schematic diagram illustrating message processing through the network environment of FIG. 1.

FIG. 3 is a functional block diagram illustrating an embodiment of the message delivery system of FIG. 1.

FIG. 4 is a functional block diagram illustrating an embodiment of information provided in an audio form to a live speaker.

FIG. 5 is a flow diagram illustrating an embodiment of a method for processing a message.

FIG. 6 is a flow diagram illustrating an embodiment of an alternative method for processing a message.

### DETAILED DESCRIPTION

A message delivery service is enhanced by integrating audio information (e.g., voice information) to a fax communication session or call. The call is established via a destination number associated with an intended recipient of a primary message. The primary message is in an intended or desired format for delivery to the recipient. The system stores at least one alternate message in a format that is different from the intended or desired format. A characteristic feature of the call is used to identify which of the primary message or the alternate message is communicated to the recipient of the call.

A message delivery job is configured by associating multimodal messages with the delivery job. For example, for a message that is intended to be sent via fax format, message information in a document or file in a format supported by the message delivery service is received along with delivery instructions. When the received message is in a non-fax format, the received message is translated or otherwise converted to a fax format such as tagged-image file format (TIFF). In this first example, the TIFF version of the message is a primary message.

A message intended to be sent to a voicemail system or voicemail message is also associated with the delivery job. The voicemail message may be received in a digital audio encoded format for example but not limited to, the moving pictures experts group 1 (MPEG-1) Audio Layer 3, more commonly referred to as MP3, waveform audio format (WAV) or Windows® audio media (WMA), in a document file format (i.e., an electronic format) or even printed text such as on paper or other physical media that can be interpreted by a human observer. Windows is the registered trademark of the Microsoft Corporation of Redmond, Wash., U.S.A.

When the voicemail message is received in a digital audio format other than a preferred digital audio encoded format, the received voicemail message is translated or otherwise converted to the preferred digital audio encoded format. When the voicemail message is received as printed text, the text is scanned and translated using optical character recognition and a text-to-speech synthesizer. The output of the text-to-speech synthesizer is further translated and stored via a suitably configured codec that generates digital audio encoded files in the preferred digital audio encoded format. A codec is a device or computer program capable of encoding and/or decoding a digital data stream or signal. When the voicemail message is received in a document format, a digital data stream generated from the information in the document is forwarded to the codec and the audio file stored. The stored audio format file is an alternate or alternative message.

A third message intended to be communicated to a live speaker is generated and associated with the delivery job. The third message can be a data stream of any desired level of complexity or a pre-recorded and stored voice message with a series of options. The pre-recorded and stored voice message may include one or more “inserts” where the pre-recorded message is paused while a customized name or phrase is communicated to the live speaker. A customized name or phrase includes information identifying the source and subject of the underlying message for the intended recipient. The customized name or phrase is encoded in a data stream that is forwarded to a speech synthesizer. When the third message is not pre-recorded, the data stream is forwarded in real time to a suitably configured speech synthesizer to communicate with the live speaker. The data stream or pre-recorded message is a second alternate message.

The primary message and one or more alternate messages are applied in accordance with a characteristic determined upon the establishment of a call with an intended recipient. An answer detector identifies when one of a fax machine, a voicemail system or answering machine, or a live speaker has answered an established call. When a fax tone is detected, the message delivery system forwards a fax format message (e.g., the primary message) to the answering fax machine. When voice energy is detected, the answer detector determines if an answering machine or a voicemail message has answered the call or whether a live speaker has answered the call.

Generally, an initial utterance by a live speaker is shorter in duration than a typical pickup message encountered when an answering machine or voicemail system answers the call. For example, a live speaker typically starts the call by saying “hello,” “good morning,” “good afternoon,” “Smith residence,” or “thank you for calling XYZ Inc. how may I help you?” On the other hand, a voicemail system or answering machine generally starts with an initial greeting such as “You've reached 555-555-5555. We're sorry we missed your call. Please make sure you leave your name and a number where we can get back to you. Thank you.”

In addition to the duration of the first utterance, it has been determined that recorded messages typically include more noise than calls with a live speaker. Thus, one or both of a threshold compared to the duration of the initial utterance and a threshold compared to an average noise across a range of audible frequencies can be used to determine when the call has been answered by a machine or a live speaker.

When the call has been answered by a machine, the message delivery system is configured to forward the voicemail message (i.e., the alternate message) to the recipient's answering machine or voicemail system. Otherwise, when the call has been picked up by a live speaker, the message delivery system is configured to forward the second alternate message.

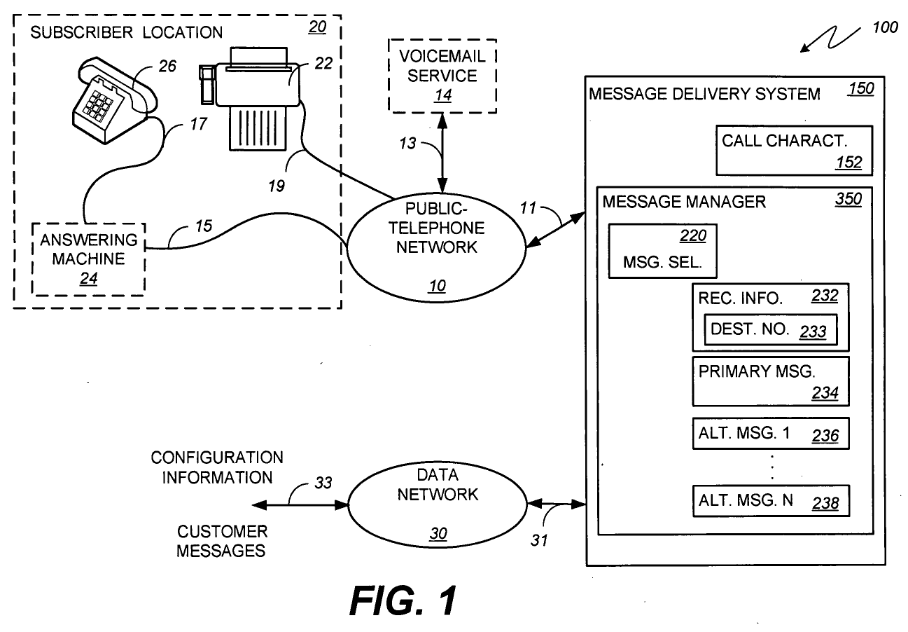

Having generally described operation of an embodiment of a dynamic message delivery system, various additional embodiments will be described with respect to FIGS. 1-6. FIG. 1 is a functional block diagram illustrating an embodiment of an example network environment. Network environment 100 includes PSTN 10, data network 30 and message delivery system 150. The message delivery system 150 is coupled to the PSTN 10 via link 11 and to the data network 30 via link 31. Both link 11 and link 31 are two-way communication channels.

The PSTN 10 is the system of interconnected telephonic devices that operate over circuit-switched networks. Originally a network of fixed-line analog telephone systems, the PSTN 10 is now almost entirely digital and includes mobile as well as fixed telephones. The PSTN 10 is largely governed by technical standards created by the Telecommunication Standardization Sector of the International Telecommunication Union (ITU-T). The PSTN 10 uses E.163/E.164 addresses (more commonly known as telephone numbers) for addressing.

The data network 30 is a system of interconnected communication devices that interchange data. The data network 30 uses one or more protocols or sets of rules for data representation, signaling, authentication, error detection and error correction that permit interconnected devices to communicate over imperfect communication channels. Portions of the data network 30 can be wired or wireless and are compatible with packet switched communication protocols.

A facsimile machine 22, an optional voicemail service 14, an optional answering machine 24 and a telephone 26 are coupled to the PSTN 10. The voicemail service 14 is coupled to the PSTN 10 on connection 13. The answering machine 24 is coupled to the PSTN 10 on connection 15. The telephone 26 is coupled to the PSTN 10 by connection 15, the answering machine 24, and by connection 17. The facsimile machine 22 is coupled to the PSTN via connection 19. As illustrated in FIG. 1, the facsimile machine 22, the telephone 26 and the optional answering machine 24 are located at a subscriber location. A subscriber of a phone service is assigned a respective destination number for each of connection 15 and connection 19. When the destination number associated with connection 19 is entered by a device coupled to the PSTN 10, the PSTN 10 connects the device to the facsimile machine 22. Similarly, when a device coupled to the PSTN 10 enters the destination number associated with connection 15, the PSTN 10 connects the device to the telephone 26.

In a first example embodiment of the network environment 100, the voicemail service 14 is configured to answer calls and record messages from callers of a destination number associated with a phone and voicemail service subscriber. The phone and voicemail service subscriber configures the voicemail service 14 by recording one or more messages associated with respective voicemail accounts and by selecting a parameter that directs the voicemail service 14 to answer calls with or without a desired delay. One or more of the voicemail accounts may be configured for access by an individual that resides or works at a subscriber location. Alternatively, one or more of the voicemail accounts may be shared by multiple parties at a subscriber location. Recorded messages, stored by the voicemail service 14 are accessed by a party at the subscriber location after entering an appropriate voicemail account identifier and possibly an access authorization code. Reviewed messages can be deleted or saved as desired by a reviewer of the stored voicemail messages. In the first example embodiment, the answering machine 24 is removed and the telephone 26 is coupled to the PSTN 10 on connection 15 or by a combination of connection 15, a coupler (not shown) and connection 17.

In a second example embodiment of the network environment 100, the answering machine 24 is configured to answer calls and record messages from callers of a destination number associated with a phone service subscriber. The phone service subscriber configures the answering machine 24 by recording one or more messages associated with respective accounts and by selecting a parameter that directs the answering machine 24 to answer calls with or without a desired delay. One or more of the respective accounts may be configured for access by an individual that resides or works at a subscriber location. Alternatively, one or more of the accounts may be shared by multiple parties at a subscriber location. Recorded messages, stored by the answering machine 24 are accessed by a party at the subscriber location after entering an appropriate account identifier and possibly an access authorization code. Reviewed messages can be deleted or saved as desired by a reviewer of the stored messages. In this second example embodiment, the voicemail service 14 is removed.

The illustrated embodiment of FIG. 1 shows a subscriber location 20 that is served by separate connections for voice and facsimile calls. In an alternative embodiment a phone router (not shown) is connected in series between the PSTN 10 and subscriber devices. The phone router answers calls to the subscriber location 20 and delivers voice, facsimile and modem calls to devices suitable for receiving each of voice, facsimile or modem calls. The phone router permits a subscriber to receive calls in multiple formats while subscribing to phone service using a single destination number.

As illustrated in FIG. 1, configuration information and messages are communicated via connection 33, the data network 30 and connection 31 to the message delivery system 150. The message delivery system 150 includes a message manager 350 that receives, stores, and distributes multimodal messages. Customers of a message delivery service operated by the message delivery system 150 use connection 33, the data network 30, and connection 31 to communicate instructions and multimodal messages to the message manager 350. The instructions include recipient information 232 and one or more destination or telephone numbers 233. A primary message 234 is communicated and stored in an intended format for delivery to an identified recipient via a destination or telephone number 233. A first alternate message 236 is communicated and stored in a second format different from the intended format for delivery to the recipient. A second alternate message 238 is also communicated and stored in a third format different from the intended format and the second format.

The message manager 350, operating under instructions communicated by a customer of the message delivery service, uses the destination number 233 to establish a call via connection 11 and the PSTN 10. In accordance with a call characteristic 152, a message selector 220 associated with the message manager 350 forwards one of the primary message 234 or an alternate message (e.g., alternate message 236 or alternate message 238) to a recipient via the PSTN 10.

The network environment 100 illustrated in FIG. 1 is not the only contemplated embodiment. For example, the message delivery system 150 may receive configuration information and messages by communication channels other than the data network 30. A customer of a message delivery service implemented by the message delivery system 150 may communicate configuration information and messages via the PSTN 10 by one or more of voice, facsimile, or data modem. By way of further example, a customer of a message delivery service implemented by the message delivery system 150 may mail or otherwise deliver instructions, recipient lists and messages to an agent of the message delivery service. When this is the case, the agent of the message delivery service will store the delivery instructions, including the recipient information 232 and the destination number 233. In addition, the agent will generate and store the primary message 234, the alternate message 236 and the alternate message 238 in the respective formats.

In the example embodiment illustrated in FIG. 1, the voicemail service 14 is separate from the PSTN 10. It should be understood that the devices that implement the corresponding functions of the voicemail service 14 can be integrated within the PSTN 10.

It should be further understood that each of the illustrated communication connections such as connection 11, connection 13, connection 15, connection 17, connection 19, connection 31, and connection 33 may be partially or entirely enabled wirelessly.

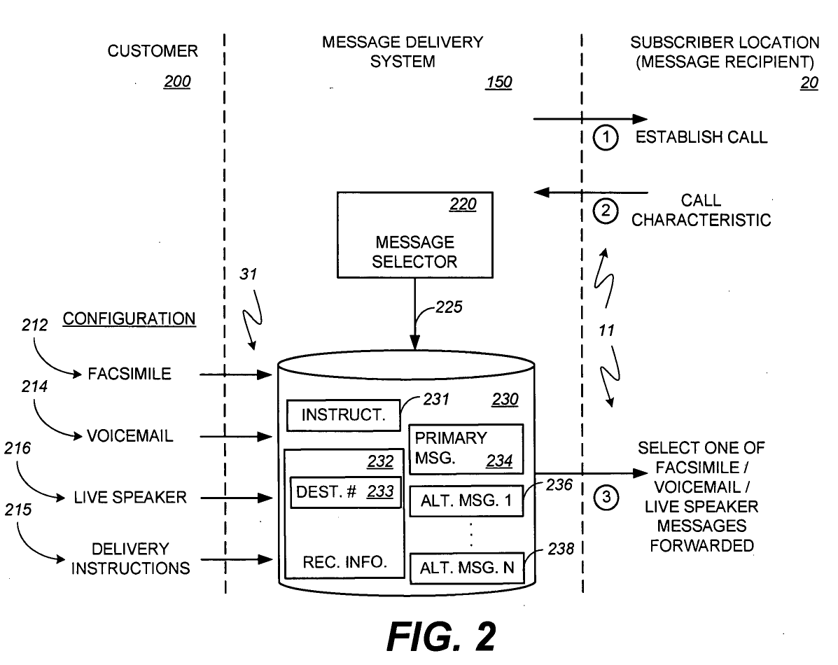

FIG. 2 is a schematic diagram illustrating message processing through the network environment 100 of FIG. 1. In the example embodiment, the message delivery system 150 communicates with a customer 200 on connection 31. The connection 31 is a data network compatible communication link.

While the connection 31 is a preferred communication channel for receiving configuration information from a customer 200 of a message delivery service implemented by the message delivery system 150, the message delivery system 150 is not so limited. For example, configuration information can be communicated via post, courier, telephone, fax, or in person to one or more agents of the message delivery service. When configuration information is communicated in one of these alternative communication channels, one or more agents of the message delivery service will enter the delivery instructions and recipient information as well as the primary message and a one or more alternate messages in a data store 230.

The message delivery system 150 also communicates with a message recipient at a subscriber location 20 on connection 11. The connection 11 is a telephone line that is addressable via a destination number or telephone number.

The customer 200 forwards a facsimile message 212, a voicemail message 214, a live speaker message 216, i.e., a message targeted for a person that answers a call along with delivery instructions and recipient information 215 for sending one or more of the facsimile message 212, the voicemail message 214 and the live speaker message. The delivery instructions and recipient information 215 include a date when the message delivery system 150 is directed to attempt to deliver a message to an identified recipient. The delivery instructions and recipient information 215 further include a destination number (i.e., a telephone number) and an indication of the customer's intended format for delivery to the recipient. The delivery instructions and recipient information 215 may optionally include one or more indicators that define a preferred range of time for delivering the message, as well as the name of the customer and the subject matter of a message to be communicated to the recipient. The delivery instructions and recipient information 215 are saved by the message delivery system 150. In the illustrated embodiment, the recipient information is stored in a recipient information location 232 in data store 230, the destination number is stored in a destination number location 233 and the delivery instructions 215 are stored in an instruction location 231.

Other storage arrangements are contemplated. For example, each of the instruction location 231, the recipient information location 232 and the destination number location 233 may be stored separate from each other. By way of further example, the instruction location 231, the recipient information location 232 and the destination number location 233 can be stored in one or more hierarchical arrangements other than the illustrated embodiment.

A facsimile message 212 is preferably delivered to the message delivery system 150 in a file format that is compatible with facsimile data transmissions. When the facsimile message 212 is a TIFF file and the delivery instructions indicate that the facsimile message 212 is the intended format for delivery to the message recipient, the message delivery system 150 stores the facsimile message 212 in a primary message location 234 in data store 230. Otherwise, when the facsimile message 212 is delivered in a format that is not compatible with facsimile data transmissions, the message delivery service 150 is configured to identify the format and apply a suitable translator for converting the received facsimile message 212 into one of a TIFF file or another file format compatible with facsimile data transmissions before saving the translated file in the primary message location 234. When the facsimile message 212 is stored in the primary message location 234, the voicemail message 214 will be stored in the alternate message location 236. The voicemail message 214 is preferably delivered to the message delivery system 150 in a digital audio encoded format such as a MP3 file, a WAV format file or a WMA format file. Such digital file formats can be received and indexed or otherwise stored in the alternate message location 236. When the voicemail message 214 is communicated to the message delivery system 150 in a format other than a digital audio encoded format, the voicemail message 214 is forwarded to a suitably configured translator such as a text to speech synthesizer to generate a pre-recorded alternate message.

When the delivery instructions indicate that the facsimile format message 212 is an alternate format for delivery to the message recipient and the facsimile message 212 is delivered in a format that is compatible with facsimile data transmissions, the message delivery system 150 stores the facsimile message 212 in a first alternate message location 236. Otherwise, when the facsimile message 212 is delivered in a format that is not compatible with facsimile data transmissions, the message delivery service 150 is configured to identify the format and apply a suitable translator for converting the received facsimile message 212 into one of a TIFF file or another file format compatible with facsimile data transmissions before saving the translated file in the alternate message location 236. When the facsimile message 212 is stored in the alternate message location 236, the voicemail message 214 will be stored in the primary message location 234. The voicemail message 214 is preferably delivered to the message delivery system 150 in a digital audio encoded format such as a MP3 file, a WAV format file or a WMA format file. Such digital file formats can be received and indexed or otherwise stored in the alternate message location 236. When the voicemail message 214 is communicated to the message delivery system 150 in a format other than a digital audio encoded format, the voicemail message 214 is forwarded to a suitably configured translator such as a text-to-speech synthesizer to generate a pre-recorded voicemail message that is stored in the primary message location 234.

As indicated by the encircled number “1,” the message delivery system 150, operating in accordance with the delivery instructions and recipient information 215 establishes a call on connection 11 to the phone service subscriber (or message recipient) 20. As further indicated by the encircled “2,” the message delivery system 150 monitors the call to identify one or more call characteristics that identify the device that answered the call or whether a live speaker has answered the call. As further indicated by the encircled “3,” the message delivery system 150 responds to an indication that a facsimile machine, an answering machine/voicemail system or a live speaker has answered the call by communicating one of the facsimile message, a voicemail message or a message suitable for a live speaker as previously stored in one of the primary message location 234, the alternate message location 236, and the alternate message location 238.

For example, when the customer 200 instructs the message delivery system 150 to deliver a facsimile format message as the intended delivery format and the message selector 220 has received an indication that a facsimile machine has answered the call, the message delivery system 150 communicates the facsimile format message from the primary message location 234. When an answering machine or voicemail system has answered the call (and the customer's intended delivery format is a facsimile message) the message delivery system 150 communicates a voicemail message from the alternate message location 236. When a live speaker has answered the call, the message delivery system 150 communicates a scripted message that provides an option or options for the live speaker to communicate with the message delivery system 150. The scripted message may be pre-recorded and stored in alternate message location 238.

By way of further example, when the customer 200 instructs the message delivery system 150 to deliver a voicemail message as the intended delivery format and the message selector 220 has received an indication that a facsimile machine has answered the call, the message delivery system 150 communicates the facsimile message 212 as stored in the alternate message location 236. When an answering machine or voicemail system has answered the call, the message delivery system 150 communicates a voicemail compatible message as previously stored in the primary message location 234. When a live speaker has answered the call, the message delivery system 150 communicates a scripted message that provides an option or options for the live speaker to communicate with the message delivery system 150. The scripted message may be pre-recorded and stored in alternate message location 238.

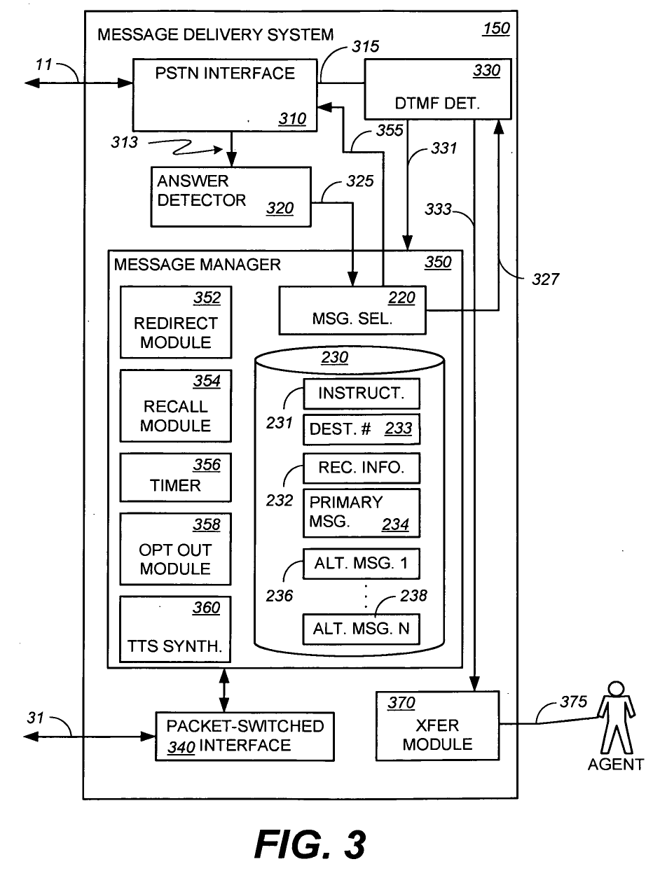

FIG. 3 is a functional block diagram illustrating an embodiment of the message delivery system 150 of FIG. 1. The message delivery system 150 includes a PSTN interface 310, an answer detector 320, a dual-tone multiple frequency (DTMF) detector 330, a packet-switched interface 340, a message manager 350 and a transfer module 370. The PSTN interface 310, answer detector 320, DTMF detector 330, packet-switched interface 340, message manager 350 and transfer module 370 are hardware devices for performing the described functions. A portion or portions of one or more of the above devices may be implemented using software and or firmware.

The packet-switched interface 340 is coupled to the data network 30 using the connection 31. As described above, customers of a message delivery service operated by the message delivery system 150 communicate message delivery instructions, recipient information, a destination number, a primary message, a first alternate message and a second alternate message using the packet-switched interface 340 or otherwise communicating with an agent of the message delivery service. The message delivery system 150 may include an application programming interface (not shown) or one or more pages of information accessible via the world-wide web to assist customers of the message delivery service in communicating suitable message delivery instructions, recipient information, a destination number and the primary and alternate messages. As described above, the data store 230 includes respective storage locations for the customer provided information. For example, delivery instructions are saved in instruction location 231. A destination number is saved in destination number location 233. Recipient information is stored in recipient information location 232. In addition, a primary message in an intended format for delivery to the recipient is saved in primary message location 234. An alternate message stored in an audio format is saved in alternate message location 236 and a scripted message suitable for interfacing with a live speaker is saved in alternate message location 238.

The PSTN interface 310 is coupled to the PSTN 10 via connection 11. In addition, the PSTN interface 310 is coupled to the answer detector 320 via connection 313 and to the DTMF detector 330 via connection 315. The PSTN interface 310 provides call information to the answer detector 320 on the connection 313 and call information to the DTMF detector 330 on the connection 315. The answer detector 320 determines which of a facsimile machine, a voicemail service (or answering machine) and a live speaker have answered a call. The answer detector 320 generates an indicator that identifies which of the devices or a live speaker has answered the call and communicates the indicator on connection 325 to the message selector 220 of the message manager 350. The indicator can be an encoded signal communicated on one or more conductors forming the connection 325. When the answer detector 320 determines that a facsimile machine generated handshake tone is present in the call information, the answer detector modifies the indicator to direct the message selector 220 to forward the message in the primary message location 234 on the call. The handshake tone is a first characteristic of a call. As explained above, the answer detector 320 applies one or both of a threshold compared to a measure of the duration of the initial utterance and a threshold compared to a measure of the average noise across a range of audible frequencies to determine when the call has been answered by a machine or a live speaker. A measure of the duration of an initial utterance and a measure of the average noise across a range of audible frequencies are additional characteristics of a call. When a voicemail service or an answering machine has answered the call, the answer detector 320 modifies the indicator to direct the message selector 220 to play the message stored in the alternate message location 236.

Otherwise, when a live speaker has answered the call, the answer detector 320 modifies the indicator to direct the message selector 220 to enable the DTMF detector 330 and play the message stored in alternate message location 238. The message manager 350 plays a stored message over connection 355 which is coupled to the PSTN interface 310. In addition, when a live speaker has answered the call, the message selector 220 applies a signal on connection 327 to enable the DTMF detector 330. The DTMF detector 330 is configured to identify which of the call-control keys or a combination of call-control keys on a telephonic device have been selected by an operator (i.e., a live speaker) that has answered a call. The DTMF detector 330 forwards an indication of a selected call-control key to the message manager 350 on connection 331. In addition, the DTMF detector 330 further sends a signal on connection 333 to enable a call transfer module 370 to connect a live speaker to an agent of the message delivery service, when the DTMF detector 330 identifies that a select call-control key or combination of call-control keys have been selected by a live speaker.

As described briefly above, the message manager 350 in accordance with an indicator received from the answer detector 320 identifies a primary message and at least one alternate message to be delivered to a recipient. The primary message is compatible with an intended format for delivery to the recipient. The alternate message is compatible with a second format different from the intended format for delivery to the recipient. The message manager 350 selects the identified file from the data store 230 and plays or otherwise delivers one of the primary message and the at least one alternate message in response to an indicator from the answer detector 320.

As further illustrated in FIG. 3, the message manager 350 includes a redirect module 352, a recall module 354, a timer 356, an opt out module 358 and a text-to-speech synthesizer 360. The redirect module 352 is responsive to a first control input (e.g., a call-control key) entered by a live speaker on a telephonic device. Upon receipt of a select control input, the message manager 350 selects and plays an audio file that prompts the live speaker to enter a new destination number. The new destination number is recorded from a series of call-control keys entered by the live speaker. Upon receipt of a select number of digits, the message manager 350 replaces the destination number in the destination number location 233 with the new destination number entered by the live speaker.

Upon receipt of a second select control input different from the first control input, the message manager 350 enables a recall module 354 that terminates the call, enables the timer 356 and attempts to establish a repeat call, using the destination number, to send the primary message after expiration of the timer 356. Upon receipt of a third select control input different from the first and second control inputs, the message manager 350, selects an audio format file that includes a message suitable for communication with a transducer associated with a telephonic device for playback. Upon receipt of a fourth control input, different from the first three control inputs, the message manager 350 enables an opt-out module 358. The opt-out module 358 prevents the message delivery system 150 from attempting to establish a future call to the recipient using the destination number. The opt-out module 358 prevents the message delivery system 150 from making future calls by deleting at least a portion of the destination number or otherwise setting a flag or other marker. The opt-out module 358 is further configured to notify the customer that the recipient has elected to remove their destination number from the message distribution list.

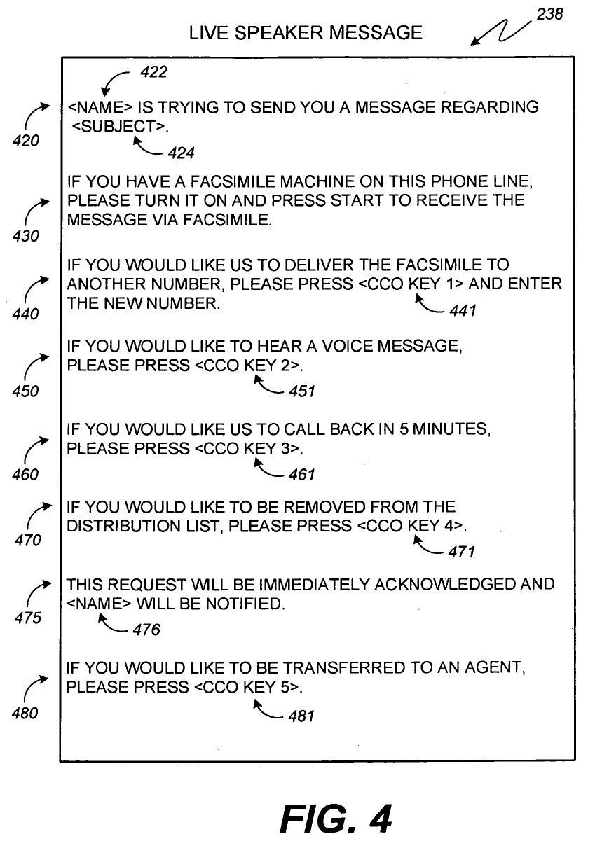

FIG. 4 is a schematic diagram illustrating an embodiment of information provided in an audio form to a live speaker. More specifically, the diagram is a textual representation of an alternate message 238 suitable for playback to a live speaker. The alternate message 238 begins with statement 420, which indicates that a customer of the message delivery service operated by the message delivery system 150 is trying to send a message concerning a specific subject. As further indicated in FIG. 4, the statement 420 includes a name insert 422 and a subject insert 424. The name insert 422 includes the name of the customer attempting to send the message. The subject insert 424 includes a brief description of the subject matter to be communicated in the message. One or both of the name insert 422 and the subject insert 424 can be pre-recorded or generated on-the-fly by a text-to-speech synthesizer 360 (FIG. 3).

The alternate message 238 continues with statement 430, which, in the illustrated embodiment, includes instructions to the live speaker to configure and start a facsimile machine if one is connected to the phone line. Thereafter, the message delivery system 150 is configured to wait a predetermined length of time for the facsimile machine to communicate a handshake tone. If no handshake tone is received before expiration of the predetermined length of time, the message delivery system 150 responds by playing back the audio message in alternate message location 236.

Thereafter, the message delivery system 150 continues with statement 440 of the alternate message 238, which includes an instruction for the live speaker to enter a call-control option 441 (labeled CCO in FIG. 4) when the live speaker wants to direct a facsimile format message to another telephone number. The call-control option 441 can be any one of the keys on a telephonic device. Thereafter, the live speaker is prompted to enter a proposed alternative destination number. The message delivery system 150 is configured to acknowledge the same via an audio recitation of the proposed destination number. If the live speaker does not disconnect the call before a predetermined length of time, the message delivery system 150 disconnects the call upon expiration of the predetermined length of time.

While the call-control option 441 is described above as consisting of any one of the keys on a telephonic device, the message delivery system 150 is not so limited. For example, the call-control option 441 can be any desired combination of the keys on a telephonic device. Should circumstances warrant the presentation of ten or more options to a live speaker, the tenth and subsequent call-control options may be selected by entering two of the keys on a telephonic device in a prescribed sequence.

Next, the alternate message 238 continues with the statement 450, which presents the option for the live speaker to listen to an audio message upon entering an identified call-control option 451. The audio message includes the information stored in alternate message 236. The audio message may be pre-recorded or may be generated in real time by a text-to-speech synthesizer. The call-control option 451 can be any one of the keys on a telephonic device (or any combination of keys) on a telephonic device that is different from the call-control option 441. Upon playback of the audio message, the message delivery system 150 may simply repeat the message until the live speaker disconnects the call, or the message delivery system 150 may prompt the live speaker to enter an additional call-control option to repeat the message.

The alternate message 238 further includes the statement 460, which presents the live speaker with the option to receive a call at a later time upon entering call-control option 461. The call-control option 461 can be any one of the keys on a telephonic device or any combination of keys on a telephonic device that is different from the call-control option 441 and different from the call-control option 451. Upon receipt of call-control option 461, the message delivery system 150 initiates a timer. After expiration of a predetermined length of time the message delivery system 150 establishes a repeat call to the message recipient using the destination number.

In addition, the alternate message 238 includes statement 470. The statement 470 presents an opt-out feature to the live speaker which is enabled by entering call-control option 471. The opt-out feature removes or otherwise blocks the message delivery service 150 from establishing future calls to the present destination number. This prevents a recipient of a misdirected call from receiving multiple repeat calls in an attempt to deliver the message. The call-control option 471 is different from the other call-control option keys. Upon receipt of the call-control option 471, the message delivery system 150 communicates the statement 475 to the live speaker. The statement 475 includes an acknowledgement of the request to be removed from the message distribution list and indicates that the customer of the message service that is attempting to send the message will be contacted. The name insert 476 can be pre-recorded or generated on-the-fly by the text-to-speech synthesizer 360 (FIG. 3)

Thereafter, the alternate message 238 includes the statement 480, which presents an option for the live speaker to be connected to an agent of the message delivery service upon entering the call-control option 481. The call-control option 481 is different from the other call-control options keys. Upon receipt of the call-control option 481, the message delivery system 150 connects the call to an agent of the message delivery service. The agent is then available to address any additional questions or concerns of the live answerer of the call. Either one of the live speaker or the agent can disconnect the call as desired.

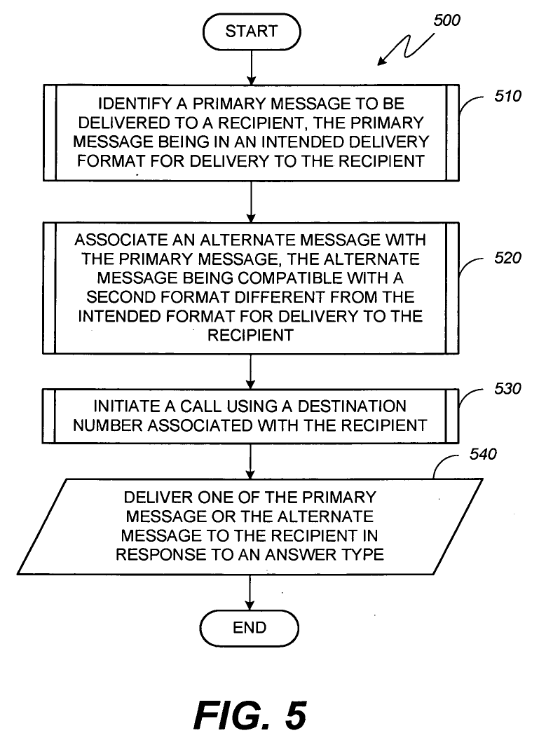

FIG. 5 is a flow diagram illustrating an embodiment of a method 500 for processing a message. The flow diagram of FIG. 5 shows the architecture, functionality, and operation of a possible implementation via hardware or combinations of hardware and software or hardware and firmware associated with communicatively coupled devices. In this regard, each block represents a subsystem, a circuit, a module, a segment, or a portion of code, which comprises one or more executable instructions for implementing the specified function(s).

In block 510, a message delivery system 150 identifies a primary message to be delivered to a recipient. As indicated in block 510, the primary message is in an intended delivery format for delivering the message to the message recipient. In block 520, the message delivery system 150 associates an alternate message with the primary message. As further indicated in block 520 the alternate message is compatible with a second format that is different from the intended format for delivery to the recipient. Thereafter, as indicated in block 530, the message delivery system 150 initiates a call using a destination number associated with the recipient. Next, as shown in data operation block 540, the message delivery system 150 delivers one of the primary message or the alternate message to the recipient in response to an answer type. As described above, the answer type is defined by information derived from the call that identifies an answerer.

For example, a facsimile “handshake” tone in the established call is indicative that a facsimile machine is connected to the circuit associated with the destination number. By way of further example, one or both of voice information exceeding a first threshold and an average noise level across a range of frequencies in the call that exceeds a noise threshold are indicative that an answering machine or a voicemail system have answered the call. Whereas, voice information that does not exceed the first threshold and an average noise level across a range of frequencies that does not exceed the noise threshold are indicative that a live caller has answered the call. When a facsimile machine has answered the call and the primary message is in a format suitable for communicating via a facsimile machine (e.g., a TIFF file) the primary message is communicated. Otherwise, when an answering machine or a voicemail service have answered the call, the message delivery system 150 selects a pre-recorded alternate message to playback for recording by the answering machine or the voicemail service. The pre-recorded alternate message communicates the message in a voiced format.

When a live speaker has answered the call, the message delivery system 150 enables a DTMF detector and selects a pre-recorded second alternate message for playback to the live speaker. As described above, the second alternate message includes one or more prompts for the live speaker to enter selections via the numbered keys on a telephonic device. In addition to identifying the source of the message and providing instruction if the intended format is compatible with a facsimile machine, the second alternate message may include one or more prompts for the live speaker to enter a new destination number for facsimile format messages, to request a call back, to hear the alternate message, to be removed from a distribution list or to be connected to an agent of the message delivery service. In some embodiments, a speech synthesizer is used to communicate with the live speaker.

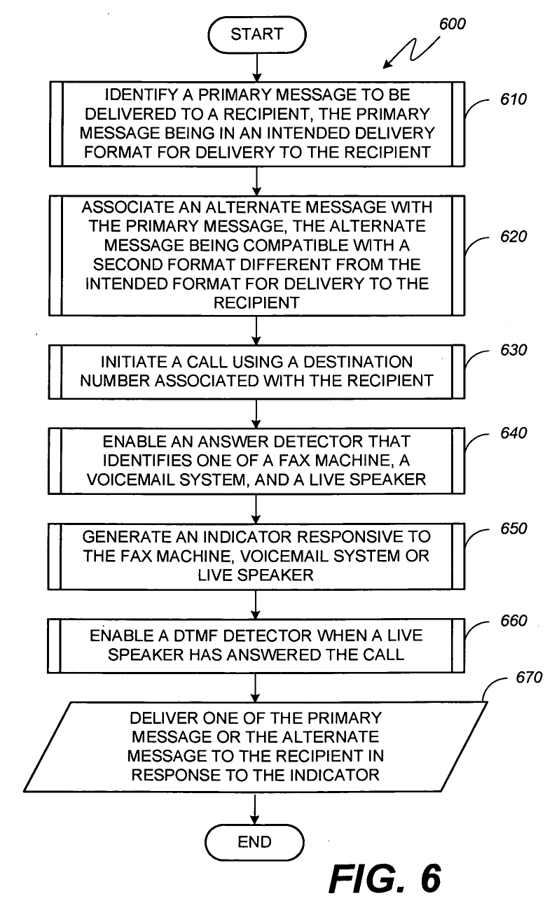

FIG. 6 is a flow diagram illustrating an embodiment of an alternative method for processing a message. The flow diagram of FIG. 6 shows the architecture, functionality, and operation of a possible implementation via hardware or combinations of hardware and software or hardware and firmware associated with communicatively coupled devices. In this regard, each block represents a subsystem, a circuit, a module, a segment, or a portion of code, which comprises one or more executable instructions for implementing the specified function(s).

In block 610, a message delivery system 150 identifies a primary message to be delivered to a recipient. As indicated in block 610, the primary message is in an intended delivery format for delivering the message to the message recipient. In block 620, the message delivery system 150 associates an alternate message with the primary message. As further indicated in block 620 the alternate message is compatible with a second format that is different from the intended format for delivery to the recipient. Thereafter, as indicated in block 630, the message delivery system 150 initiates a call using a destination number associated with the recipient. Next, as shown in data operation block 640, the message delivery system 150 enables an answer detector that identifies an answerer of the call as one of a facsimile machine, a voicemail system/answering machine and a live speaker. That is, the answer detector identifies an answer type. As indicated in block 650, the message delivery system 150 generates an indicator responsive to the answerer or answering device. That is, the indicator communicates which of a facsimile machine, a voicemail system/answering machine or a live speaker have answered the call. As described above, the indicator may be communicated in an encoded signal or combination of signals to identify multiple answer types. When the indicator indicates that a live speaker has answered the call, the message delivery system 150 enables a DTMF detector, as indicated in block 660. Thereafter, as indicated in data operation block 670, the message delivery system 150 delivers one of the primary message or the alternate message to the recipient in response to the indicator.

As described above, the message delivery system 150 responds to a voicemail system/answering machine by playing a pre-recorded alternate message. The pre-recorded alternate message communicates similar or different information than that included in the primary message. The pre-recorded alternate message is in a format suitable for communicating with a transducer associated with a telephonic device. In an alternative embodiment, the pre-recorded alternate message is provided and or stored in a text or document format. When the pre-recorded alternate message is selected for playback, the message information is processed by a text-to-speech synthesizer associated with the message delivery system 150.

The message delivery system 150 responds to a live speaker by playing a pre-recorded second alternate message and enabling a DTMF detector to receive information from the live speaker. As described above, the pre-recorded second alternate message may include “personalized” information identifying the source and subject of the primary message. In addition, the pre-recorded second alternate message will include one or more prompts for the live speaker to enter a call-control option key to enter a new destination number, to hear the voiced message (i.e., the pre-recorded alternate message), to receive a call at a later time, to be removed from a distribution list and to be transferred to an agent of the message delivery service. A call-control option key (i.e., one of the keys on a standard telephonic device) is associated with a predetermined response corresponding to an associated prompt. One or more of the call-control option keys may be associated with logic or switches that appropriately redirect or route the current call. In addition, one or more of the call-control option keys may be associated with logic that records a new destination number or other information communicated by the live speaker. In turn, the message delivery system 150 responds by replacing a previously communicated destination number with the new destination number provided by the live speaker.

While the message delivery system 150 has been illustrated and explained using embodiments where the primary message is in a format suitable for communicating with a facsimile machine and the pre-recorded alternate message is in a format suitable for communicating with a transducer associated with a telephonic device, the message delivery system 150 is not so limited. For example, the message delivery system 150 can receive and store a primary message in a format suitable for communicating with a recipient via a transducer associated with a telephonic device. When this is the case, the alternate message is stored in a format suitable for communicating with a facsimile machine. By way of further example, the message delivery system 150 may receive and store messages in a document (i.e., electronic) or text format (i.e., printed or handwritten). Messages stored in a document or text format that are designated for delivery via a transducer associated with a telephonic device may be pre-processed by a text-to-speech synthesizer and/or one or more optical character recognition elements associated with the message delivery system 150. Alternatively, as described above, customized message “inserts” may be generated and inserted into a pre-recorded audio format message to communicate the source, the subject, or other information to the recipient of the message.

As described above, the flow diagrams of FIG. 5 and FIG. 6 show the architecture, functionality and operation of an implementation of example methods for communicating multimodal messages. The described functions can be embodied in source code including human-readable statements written in a programming language or machine code that comprises instructions recognizable by a suitable execution system such as a processor in a computer system. The machine code may be produced from the source code, etc. If embodied in hardware, each block may represent a circuit or a number of interconnected circuits to implement the specified logical function(s).

The foregoing description has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the present systems and methods. All such modifications and variations are within the scope of the appended claims when interpreted in accordance with the breadth to which they are fairly and legally entitled.

What is claimed is:

1. A method for processing a message, comprising:
identifying a primary message to be delivered to a recipient, the primary message being compatible with an intended format for delivery to the recipient;
associating an alternate message with the primary message, the alternate message being compatible with a second format different from the intended format for delivery to the recipient;
initiating a call using a destination number associated with the recipient; and
delivering one of the primary message or the alternate message to the recipient during the call in response to an answer type.

2. The method of claim 1, further comprising:
enabling an answer detector configured to identify when one of a facsimile machine, a voicemail system, and a live speaker answers the call.

3. The method of claim 2, wherein the answer detector generates an encoded signal to identify the answer type.

4. The method of claim 2, further comprising enabling a DTMF detector when the answer detector identifies that a live speaker has answered the call.

5. The method of claim 4, further comprising responding to a select DTMF key in a predetermined manner.

6. The method of claim 1, wherein the primary message is in a format suitable for communicating with a facsimile machine.

7. The method of claim 1, wherein the alternative message is in a format suitable for communicating via a transducer.

8. The method of claim 1, wherein the alternative message is in a text format.

9. The method of claim 8, further comprising processing the alternate message with a text-to-speech synthesizer.

10. The method of claim 1, wherein the primary message is in a format suitable for communicating via a transducer.

11. The method of claim 1, wherein the alternative message is in a format suitable for communicating with a facsimile machine.

12. The method of claim 1, further comprising modifying information in response to an input entered by a live speaker.

13. A dynamic message delivery system, comprising:
a public-switched telephone network interface in communication with the public-switched telephone network;
an answer detector coupled to the public-switched telephone network interface and configured to generate an indicator responsive to an answer type; and
a message manager coupled to the public-switched telephone network interface and arranged to receive the indicator, the message manager configured to identify a primary message and an alternate message to be delivered to a recipient, the primary message being compatible with an intended format for delivery to the recipient, the alternate message being compatible with a second format different from the intended format for delivery to the recipient, the message manager further configured to deliver one of the primary message or the alternate message in response to the indicator.

14. The dynamic message delivery system of claim 13, wherein the answer detector is configured to vary the indicator to identify when one of a facsimile machine, a voicemail system, and a live speaker answers the call.

15. The dynamic message delivery system of claim 13, wherein the message manager is configured to select a file from a data store.

16. The dynamic message delivery system of claim 13, further comprising a DTMF detector configured to identify a control input entered via the call.

17. The dynamic message delivery system of claim 16, further comprising a transfer module configured to connect a live speaker to an agent upon receipt of the control input.

18. The dynamic message delivery system of claim 16, wherein upon receipt of the control input, the message manager selects and enables a playback of an audio file that prompts the live speaker to enter a new destination number.

19. The dynamic message delivery system of claim 16, wherein upon receipt of the control input, the message manager removes a destination number associated with the recipient and notifies a customer of the message delivery service that the recipient has opted out of receiving messages.

20. The dynamic message delivery system of claim 16, wherein upon receipt of the control input, the message manager terminates the call, selects a timer and attempts to establish a repeat call to send the primary message after expiration of the timer.

21. The dynamic message delivery system of claim 16, wherein upon receipt of the control input, the message manager selects an audio file that contains the alternate message.
